(19) United States
(12) Patent Application Publication
(10) Pub. No.: US 2005/0066792 A1
(43) Pub. Date: Mar. 31, 2005

(54) Shoulder pads for violins and the like

(76) Inventor: Rogelio M. Mea, Lipa City (PH)

Correspondence Address: SHERIDAN ROSS PC, 1560 BROADWAY, SUITE 1200, DENVER, CO, 80202, US

(21) Appl. No.: 10/932,554

(22) Filed: Sep. 1, 2004

(30) Foreign Application Priority Data
Sep. 26, 2003 (PH) 2-2003-000396

(51) Int. Cl. G10D 1/02; G10D 3/18

(52) U.S. Cl. 84/328

(57) ABSTRACT

The construction of a shoulder rests for violins and the like comprising a generally rectangular open top elongated body having a bottom wall, opposed longitudinal side walls and opposed transverse side walls, said opposed longitudinal side walls having a plurality of protruding lugs, each having protective rubber rests at their top ends, provided thereon, and said opposed transverse side walls having flexible arms fixedly secured near the middle portion thereof.

This utility model relates in general to shoulder rests for stringed musical instruments, preferably violin or viola.

Musicians using violins, viola, and similar instruments suffer bruises and abrasions on their shoulder caused by rubbing movement of the instrument when in use.

It is therefore the primary object of the present utility model to provide a shoulder pad for these musical instrument which prevents lateral sliding movement of the instrument thereon during use thereby minimizing or somewhat eliminating bruises and abrasions on the user.

Still an object is to provide a shoulder pad which do not affect the sound quality of the instrument as there is s spaced between the pad and the instrument.

Another object is to provide a shoulder pad having flexible strap for securing the pad to the resonance box.

These and other object of the present utility model will be apparent upon reading the following detailed description taken in conjunction with the appended drawings, wherein:

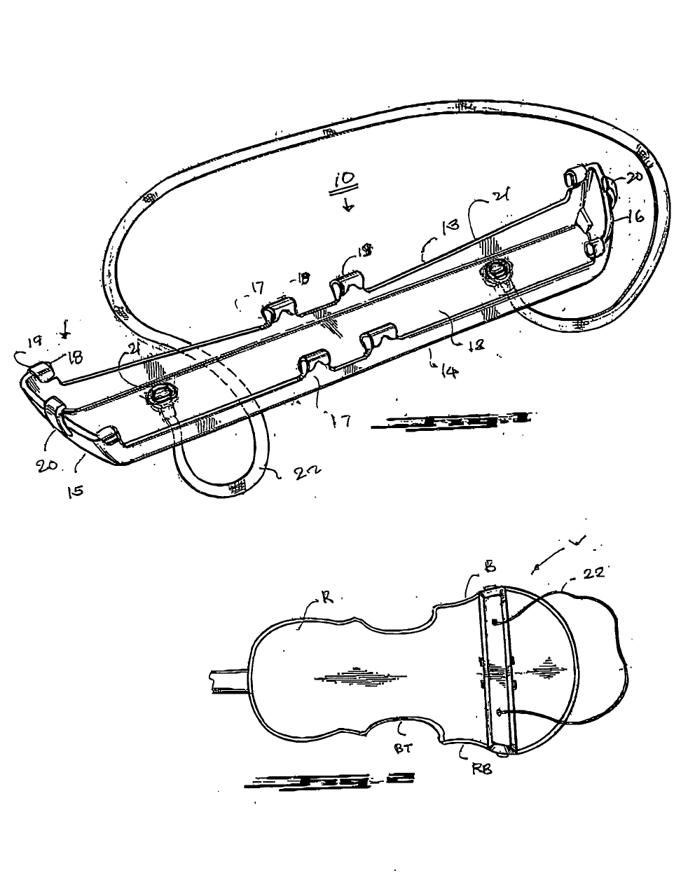

FIG. 1 is a perspective view of the shoulder pad; and

FIG. 2 is a bottom view of a violin with the shoulder pad attached thereon.

Referring now to the several views of the drawings, wherein like reference numerals designate same parts throughout, there is shown my utility model for a shoulder pad for violins and the like generally designated as 10.

Said shoulder pad 10 being mounted against the bottom surface B near the lower end portion of the resonance box R of the violin V to protect the chest or shoulder of the user.

Said shoulder pad 10 comprises a generally rectangular open top elongated body 11 made from hard plastic material, preferably polypropylene having a bottom wall 12, opposed longitudinal side walls 13 and 14 and opposed transverse side walls 15 and 16.

Said opposed longitudinal side walls 13 and 14 each having at least a pair of upwardly protruding lugs 17 at the middle portion thereof and upwardly protruding lugs 18 near the opposed corners thereof. Each lugs 17 and 18 having protective rubber pads 19 or their equivalent at their top ends.

Said opposed transverse sidewalls 15 and 16 each having flexible arms 20 fixedly secured near the middle portions thereof.

The bottom wall 12 having at least a pair of holes 21 provided near the opposed ends thereof for connection of a flexible strap 22.

When mounted against the bottom surface B of the resonance box R, the protruding lugs 17 and 18 abuts said bottom surface B providing a space between the bottom wall 12 of the shoulder pad 10 and the resonance box R, the flexible arms 20 are clipped on the rib RB of the resonance box retaining the shoulder pad 10 on the resonance box R.

The flexible strap 22 secure the shoulder pad 10 on the bouts BT of the resonance box 10 for added securement.

1. The construction of a shoulder pad for violins and the like comprising a generally rectangular open top elongated body having a bottom wall, opposed longitudinal side walls and opposed transverse side walls, said opposed longitudinal side walls having a plurality of protruding lugs, each having protective rubber pads at their top ends, provided thereon, and said opposed transverse side walls having flexible arms fixedly secured near the middle portion thereof.

2. The construction of a shoulder pad for violins and the like as claimed in claim 1 further comprising a flexible strap connected at the holes provided on said bottom wall of said elongated body.

3. The construction of a shoulder pad for violins and the like as claimed in claim 1 wherein said elongated body being made of hard plastic material, preferably polypropylene.
